(19) United States
(12) Patent Application Publication
(10) Pub. No.: US 2005/0086659 A1
(43) Pub. Date: Apr. 21, 2005

(54) System and method for regulating rate of execution of software execution units

(75) Inventors: Matthew A. Huras, Ajax (CA); Sam S. Lightstone, Toronto (CA); Sujay S. Parekh, New York, NY (US); Kevin R. Rose, Toronto (CA)

Correspondence Address: FERENCE & ASSOCIATES, 400 BROAD STREET, PITTSBURGH, PA, 15143, US

(73) Assignee: IBM Corporation, Armonk, NY (US)

(21) Appl. No.: 10/689,114

(22) Filed: Oct. 19, 2003

(51) Int. Cl. G06F 9/46

(52) U.S. Cl. 718/104; 718/102

(57) ABSTRACT

Regulating the execution of software execution units to manage the performance impact of administrative utilities is disclosed. Administrative utilities (e.g., filesystem and database backups, garbage collection in the Java Virtual Machines, etc.) are an essential part of the operation of production systems. Performance impact is managed through the use of throttling, either external or internal, which forces utilities to slow down their processing by a configurable amount. While a variety of criteria may be used for throttling, a self-induced sleep in preferred for internal throttling.

### FIELD OF THE INVENTION

This invention generally relates to regulating the execution of software execution units and, more specifically, to managing the performance impact of such execution of software execution units.

### BACKGROUND OF THE INVENTION

Software execution units (threads or processes, as appropriate), generally referred to as work performed by modern computer systems, may be considered to fall into two categories: (1) production work which is directly related to the users or purpose of the system; and (2) other work, such as tasks that are less important or those that are essential to the long-term functioning and health of the system. Non-production work in this context includes utilities, low priority applications, low priority functions within an application, and also low priority users using the system, for example, a user generating a mining report in a database application. For convenience, in the rest of this document, non-production work is referred to as “utility work”. Some examples of utility work include garbage collection, running anti-virus software, performing system backups, etc. Utility work is usually considered to be lower-priority when resolving contention for resources, such as the central processor unit (CPU), memory, bandwidth, etc. Unfortunately, resource prioritization schemes in modem operating systems do not fully address the issue of arbitrating resource contention. For example, UNIX systems allow process priorities to control CPU contention, but contention for other resources, e.g., input/output (I/O), memory, etc., are not arbitrated. Hence, the execution of non-production work on a well-utilized system will generally degrade the performance of the production work due to such contention and other overheads introduced by running the utilities.

FIG. 1 demonstrates the dramatic performance degradation from running a database backup utility (e.g., utility work) while emulated clients are running a transaction-oriented workload (e.g., production work) against that database. The throughput of the system without this backup utility (i.e., workload only) averages 15 transactions per second (tps). When the backup utility is started at t=600 sec, the throughput drops to between 25-50% of the original level, and a corresponding increase is seen in the response time. Moreover, over the duration of the utility execution, its impact on the workload decreases (indicating that the resource demands of the utility decrease).

One approach to overcome the foregoing problems is for the system administrator to carefully plan the execution of utility work during periods when the utility's impact on the production workload is low or when the system is offline. This approach is problematic because: (a) it requires a large expenditure of time and effort of the system administrator; (b) not all utilities can be deferred until such a period; (c) the window of execution may be too short for the utility to complete its tasks or perform its tasks properly; and (d) in modern 24×7 operation, such low or offline periods may be absent.

Another approach is to “throttle” utility work to a variable extent. In the context of this work, throttling refers to a lowering of the utility's rate of progress or resource consumption. For example, one may limit the rate at which memory is scanned by a garbage collector, or the I/O bandwidth consumed by a system backup. By throttling utilities to a larger extent, a system administrator may limit the impact of utilities on production work, thereby allowing the system administrator to run the utility along with production work.

A drawback of the throttling approach described above is that the progress of utility work may be unnecessarily impacted, if the throttling level is too high when the production low is low. System administrators have generally competing objectives: (1) ensuring that utilities are throttled sufficiently to prevent undue impact on production work; and (2) ensuring that managed systems are well utilized and/or that utilities finish within an acceptable time. The workload of most commercial systems varies with time, thus it is desirable to change the throttling level in response to changing workloads to optimize system resource allocation. When the production load is high the utilities should be throttled more, but when production load is low the utilities should be throttled less. Moreover, utilities which have little or no impact on the production work may not need to be throttled much or at all.

### SUMMARY OF THE INVENTION

In accordance with at least one presently preferred embodiment of the present invention, there is broadly contemplated a system and method for regulating the rate of execution of software execution units for managing performance. The system and method of the present invention are application and operating system independent ways of throttling software execution units, which allows for greater flexibility and efficiency.

In summary, one aspect of the invention provides a system for regulating resource consumption in a computer system used for utility work and production work, the apparatus comprising: an arrangement for determining the utilities within the system; an arrangement for deriving a throttling level for each utility which quantifies the reduction in the rate at which the utility consumes resources; and an arrangement for enforcing the derived throttling level for each utility.

Another aspect of the present invention provides a method for regulating resource consumption in a computer system used for utility work and production work, the method comprising the steps of: determining the utilities within the system; deriving a throttling level for each utility which quantifies the reduction in the rate at which the utility is processed or otherwise consumes resources; and enforcing the derived throttling level for each utility.

Furthermore, an additional aspect of the invention provides a program storage device readable by machine, tangibly embodying a program of instructions executable by the machine to perform method steps for regulating resource consumption in a computer system used for utility work and production work, the method comprising, said method comprising the steps of: determining the utilities within the system; deriving a throttling level for each utility which quantifies the reduction in the rate at which the utility consumes resources; and enforcing the derived throttling level for each utility.

For a better understanding of the present invention, together with other and further features and advantages thereof, reference is made to the following description, taken in conjunction with the accompanying drawings, and the scope of the invention will be pointed out in the appended claims.

### BRIEF DESCRIPTION OF THE DRAWINGS

FIG. 1 graphically shows an example of performance degradation due to running utilities.

FIG. 2 is a schematic diagram of a general purpose computer system suitable for utilizing the present invention.

FIG. 3 is a block diagram of throttling infrastructure components in accordance with the present invention.

FIG. 4 is a flow chart of the operation of a controller shown in FIG. 3.

FIG. 5 is a block diagram of throttling infrastructure components in accordance with another embodiment of the present invention.

FIG. 6 is a flow chart of the operation of an execution unit shown in FIG. 3 in accordance with the present invention.

FIG. 6(b) is a flow chart of the operation of an external throttle agent in accordance with the present invention.

FIG. 7 is a flow chart of the operation of an execution unit shown in FIG. 3 in accordance with another embodiment of the present invention.

FIG. 8 is a flow chart of the operation of an execution unit shown in FIG. 3 in accordance with a further embodiment of the present invention.

FIG. 9 shows high-level throttle agent structure in accordance with the present invention.

FIG. 10 shows high-level utility structure in accordance with the present invention.

FIG. 11 shows high-level utility structure and sleep point insertion in accordance with a further embodiment of the present invention.

FIG. 12 graphically shows average performance at different throttling levels.

FIG. 13 shows the effect of dynamically varying sleep fraction settings.

### DESCRIPTION OF THE PREFERRED EMBODIMENTS

The following detailed description of the embodiments of the present invention does not limit the implementation of the invention to any particular computer system or programming language. The present invention may be implemented in any computer programming language provided that the OS (Operating System) provides the facilities that may support the requirements of the present invention. A preferred embodiment is implemented in the C or C++ computer programming language (or other computer programming languages in conjunction with C/C++). It should also be appreciated the invention may be implemented in any number of computer systems, including embedded systems which may not have displays, disk drives, etc., as will be understood by those skilled in the art. A preferred embodiment is implemented in a computer system configured in a conventional manner as described below. Any limitations presented would be a result of a particular type of operating system, computer programming language, or computer system and would not be a limitation of the present invention.

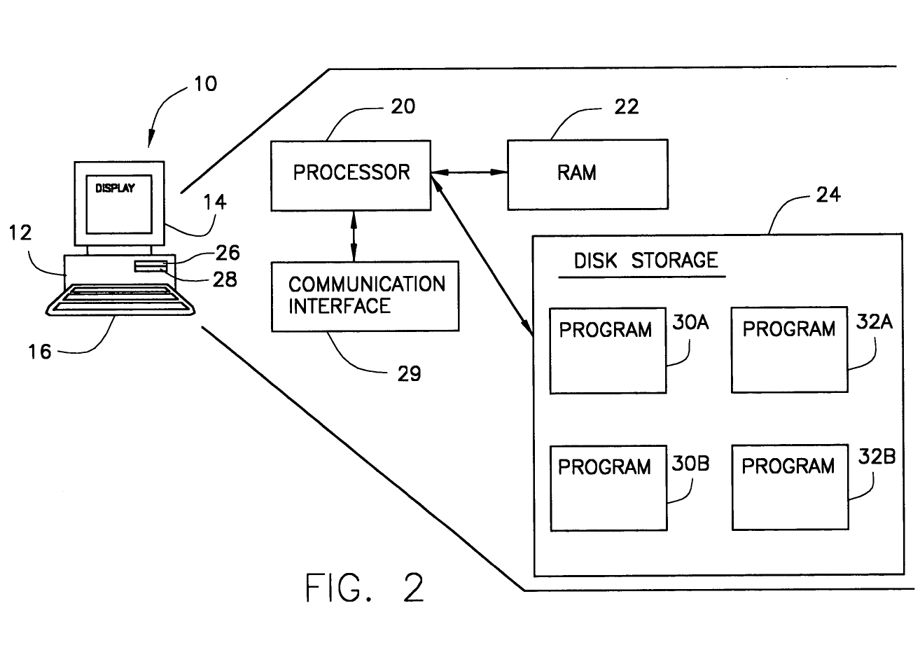

Referring now to FIG. 2, a computer system indicated by reference 10 is shown for regulating the execution of software execution units in accordance with an embodiment of the present invention. The computer system 10 as shown in FIG. 2 includes a processing unit 12, a display unit 14, and a keyboard 16 and other input devices such as a mouse (not shown). The processing unit 12 is configured in a conventional manner and includes one or more processors 20, random access memory or RAM 22, and mass storage devices, such as a hard disk drive 24, a compact disk or CD drive 26, a floppy disk drive 28, and a communication interface 29. It will be appreciated that regulating the execution of software execution units in accordance with the present invention may be accomplished on other types of computer or data processing systems, for example, on a back-end server which is configured in the same manner as the computer system 10 shown in FIG. 2, as will be understood by those skilled in the art.

The computer system 10 may be coupled to a network (not shown) via the communication interface 29. The communication interface 29 may comprise a wireless link, a telephone communication, radio communication, computer network (e.g. a Local Area Network (LAN) or a Wide Area Network (WAN)), or a connection through the Internet or World Wide Web (WWW). Computer programs for performing production work or production programs 30, indicated individually by references 30a, 30b, and computer programs for performing utility (non-production) work or utility programs 32, indicated individually by references 32a, 32b are installed on the hard disk drive 24. The computer program product 30 may include application programs such as the DB2™ database management system from IBM. The computer program product 32 may include utility programs such as garbage collection software, anti-virus software, system backup software, or may be batch jobs and other long-running background tasks. The computer program product 32 may also include utility threads such as spell-checking, grammar-checking, garbage collection (particularly in Java Virtual Machines), and the like, or in portable devices, may include utility threads for reducing power consumption of low-priority tasks. In such a situation, the metric may be the rate of battery power consumption. Alternatively, the software performing the production work and the utility work may be the same. The criterion is that the production work and the utility work are distinguishable at execution time, such as by running in separate processes or threads.

In the context of the description, work refers to processing and resource consumption that occurs in any piece of the entire computer or data processing system. Production work includes work that occurs directly on behalf of end-users of the data processing system or is otherwise directly related to the purpose of the system. Utility or non-production work refers to any maintenance or background work. Examples of non-production work or utility work include utilities, low priority applications, low priority functions within an application, and also low priority end-users using the system, e.g., a user generating a mining report in a database application.

The system for regulating the execution of software execution units according to this aspect of the invention may be implemented within a computer program product 30 for an application which runs on the computer or data processing system 10 or in a separate utility program 32 which runs on the computer system 10. In operation, the computer programs 30 and 32 are loaded from memory 24 and program instructions are generated for execution by the processor 20.

In accordance with the present invention, throttling may be added to the execution units in two principal ways. The first is self-throttling, which as discussed below requires modifications to an execution unit so it will be self-throttling. The second is external throttling, in which the execution unit need not nor cannot explicitly control its own throttling level. Rather, an external agent controls the throttling.

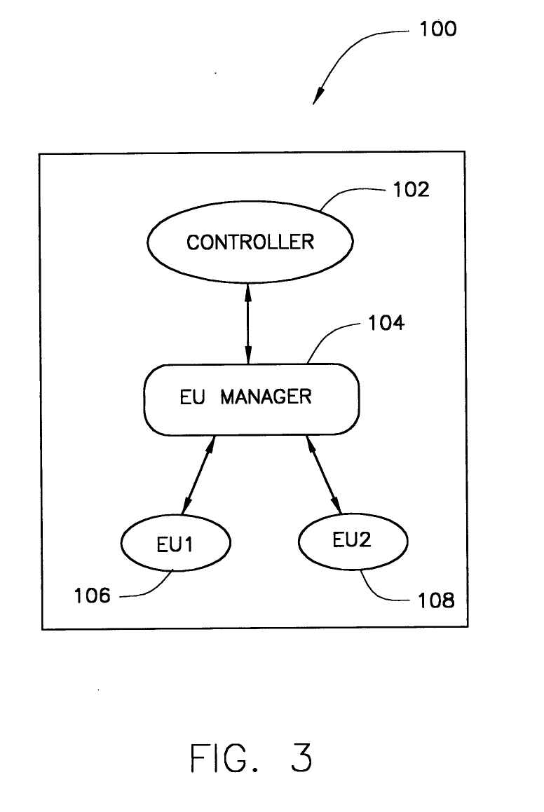

Referring now to FIG. 3, a block diagram for an implementation of a throttling system 100 according to one aspect of the present invention. The throttling system 100 is implemented in functional modules in the form of computer software or a computer program product 30 and executed by the processor 20 during operation of the computer program product 30. The throttling system 100 as shown comprises a controller module 102, a manager module 104, execution units 106 and 108. It should be understood that while one controller module and two execution units are shown, any number of controller modules and execution units may be used in accordance with the present invention.

In either embodiment, the controller module 102 is a functional module for calculating a throttling level for the utilities or the non-production work. The throttling level for each utility quantifies the reduction in execution rate or resource consumption of a utility. Typically, it is a value between 0% and 100%, where 0% indicates no reduction, and 100% indicates the utility makes no progress and/or consumes no resources. The software, e.g., the utility or execution units, controlled by the controller module is represented by references 106 and 108.

The manager module 104 preferably serves as the central aggregation point for all the information concerning execution units 106, 108. Manager module 104 is not necessarily an executing unit itself; rather, it is mainly a data structure that allows appropriates operations, according to various consumers of its services. Manager module 104 preferably handles requests to register controllers, which makes the controllers available to service control requests for execution units; requests for initialization and termination of execution units, which may involve tracking data which describes the execution unit (e.g., the start time of the execution unit, the type of metric to use, whether the execution unit starts throttled or not, and the like) and preferably is not retained when then execution unit terminates; requests from the execution units for throttling, which may involve selecting the appropriate controller and starting the controller if it is not already started, and the like. The operation of manager module 104 will be known to one of skill in the art based upon the discussion controller module 102 and execution units 106, 108.

The throttling system 100 is implemented in functional modules in the form of computer software or a computer program product 30 and executed by the processor 20 during operation of the computer program product 30. The throttling system 100 as shown comprises a controller module 102, a manager module 104, execution units 106 and 108. It should be understood that while one controller module and two execution units are shown, any number of controller modules and execution units may be used in accordance with the present invention.

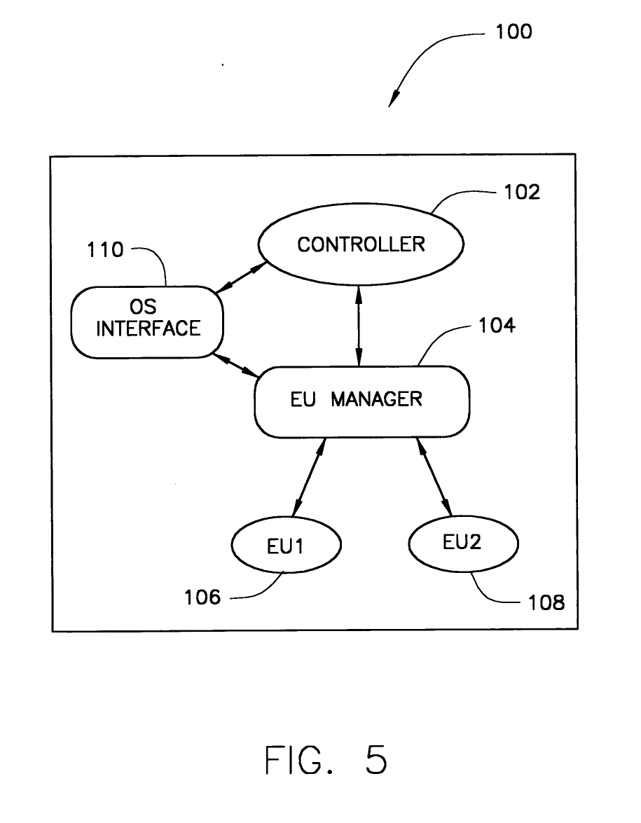

Referring now to FIG. 5, the operation of control module 102 is shown in more detail. Preferably, the controller module 102 operates on a periodic basis, i.e. every T seconds, as determined by the system designer. The controller module 102 may be implemented as a proportional-integral (PI) controller. PI controllers are typically robust and offer wide applicability. Any other types of controllers, such as proportional-derivative (PD) or proportional-integral-derivative (PID) or neural-network based ones, for example, may be used. Also, it is feasible to use controllers that are driven by events other than timer events, for example, by the arrival of specific requests, or based upon having processed a fixed number of requests. The particular choice is specific to the target computer system and is chosen by the system administrator. It is presently preferred that the controller module 102 be implemented as disclosed in the copending and commonly assigned U.S. patent application Ser. No. 10/427,009, entitled “Adaptive Throttling System for Data Processing Systems”, filed on Apr. 30, 2003, and which is hereby incorporated by reference herein.

In the first step 120, the controller module 102 registers with manager module 104. By registering, the controller informs the manager of its existence. It should be understood that multiple controllers may register with manager module 104. For example, multiple controllers may be used the system designer desires to have different control requirements for different types of execution units. In step 130 the controller module 102 obtains information from manager module 104 about the throttlable execution units in the system to be controlled by controller module 102. In step 140 controller module 102 preferably next obtains from manager module 104 performance related metrics. It should be understood that this is preferable, but not required. This information, along with the other information provided by manager module 104 is used to calculate a new throttling level (step 150 ) for each execution unit 106, 108. In step 150, the new throttling level is provided to the manager module 104, which in turn will make the new throttling level available to the appropriate execution unit 106, 108. The process is repeated while throttling services are required as indicated by decision block 160. Once throttling services are no longer needed, the controller module 102 deregisters with manager module 104 (step 170).

While the preceding paragraph discussed controller module 102 obtaining information from and providing information to manager module 104, alternatively, or in addition, controller module 102 may obtain and provide information, such as performance metrics, through means other than the manager module 104, e.g., calling operating system interfaces directly. It should be understood it is presently preferred to have this information obtained from and provided to manager module 104 to permit the performance collection functionality to be aggregated into one point, and also to allow the manager module 104 to collect application-specific metrics, since the controller module 102 may be in a different address space for safety/security purposes.

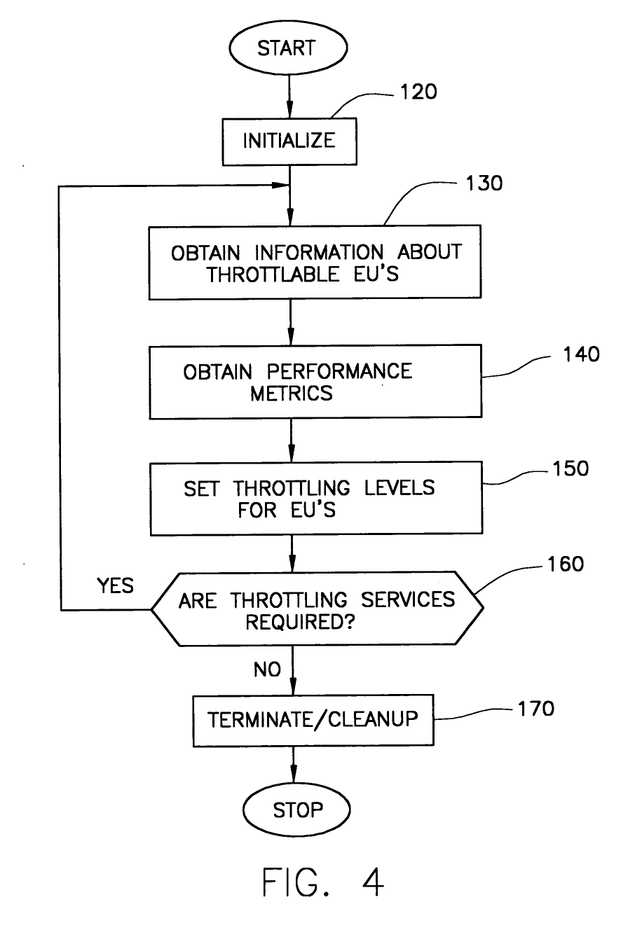

FIG. 4 shows a block diagram for an implementation of a throttling system 100 according to another aspect of the present invention in which controller module 102 may obtain and provide information, such as performance metrics, through means other than the manager module 104, e.g., calling operating system interfaces directly. This figure also includes OS interface 110, which may be in operative communication with controller module 102 or manager module 104. Typically, in this embodiment, execution units 106, 108 are not self-throttling and external throttling is accomplished in conjunction with OS interface 110.

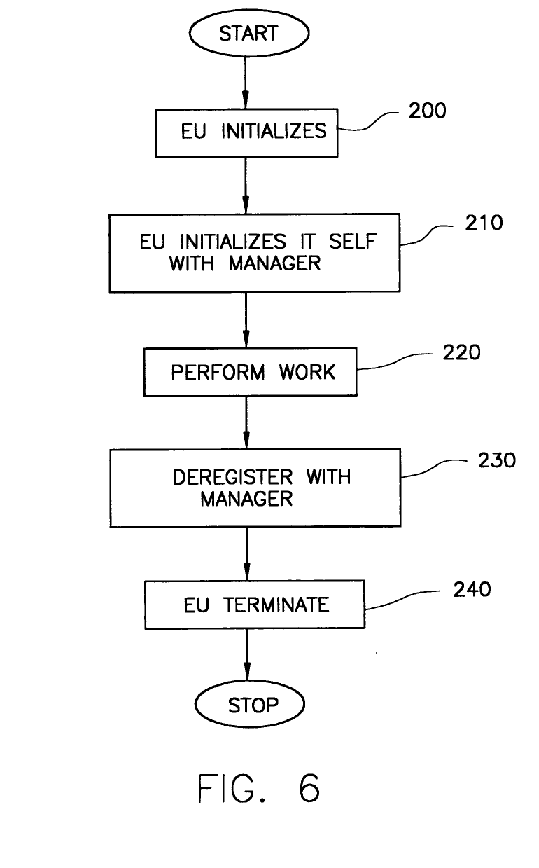

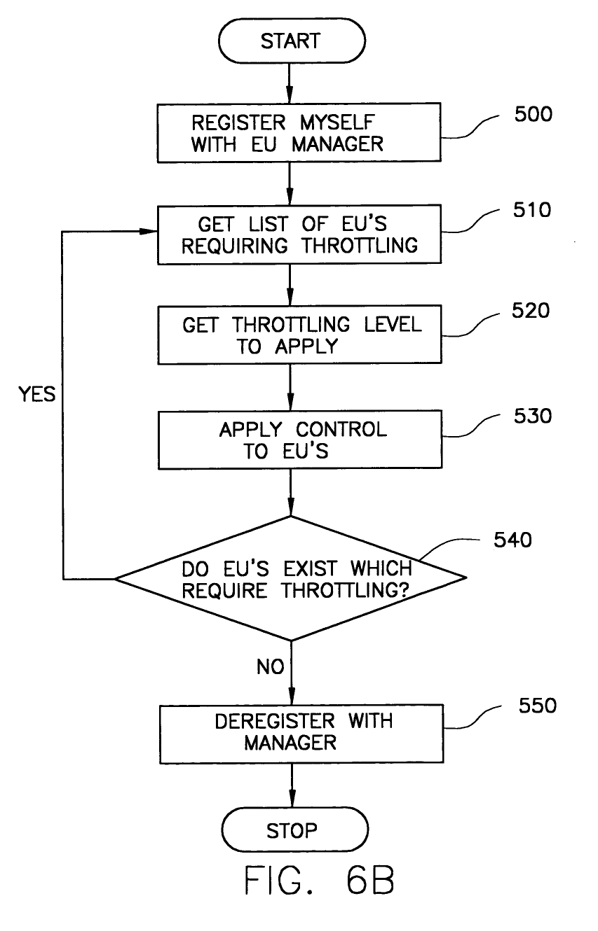

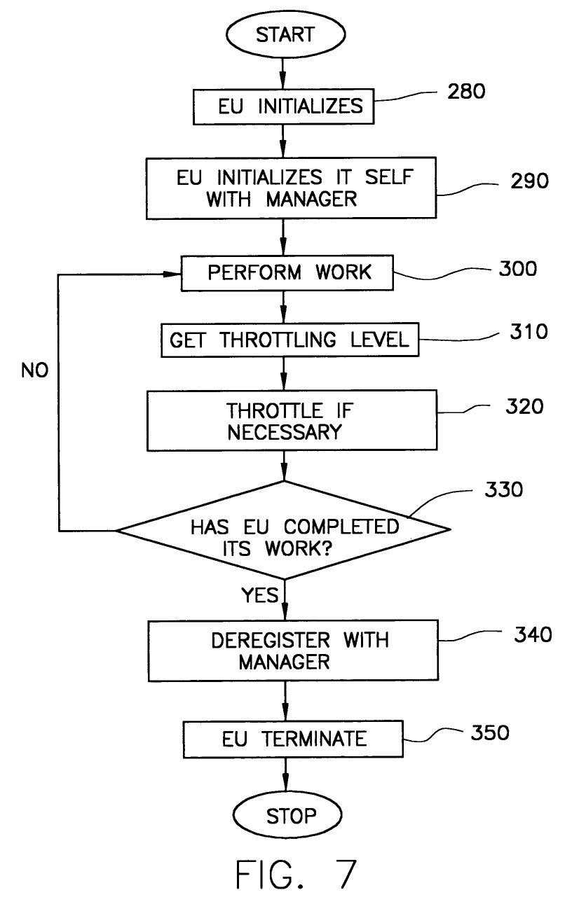

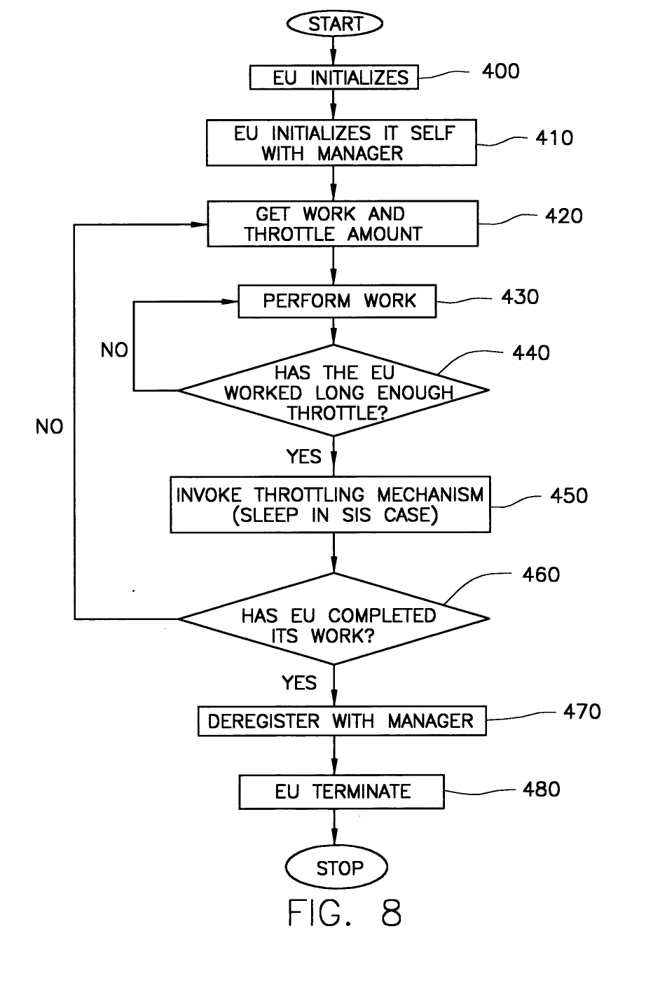

Referring now to FIGS. 6, 7, and 8, the operation of execution units 106, 108 is shown in more detail. For convenience the discussion will be limited to execution unit 106. It should be understood, however, the discussion is equally applicable to execution unit 108 or any other execution units. These figures address the situations where throttling is accomplished by an external agent (FIG. 6), throttling is generally accomplished by self-throttling (FIG. 7), and throttling is accomplished by self-throttling in a preferred manner (FIG. 8).

Referring now to FIG. 6, the operation of an execution unit where an external agent adjusts some parameter to cause the utility to throttle is shown. (The operation of an external agent in shown in FIG. 6(b).) Examples of such are controller module 102 lowering the operating system priority of the utility without the utility even knowing what its operating system priority is. For a background discussion on operating system priorities, see A. Tanenbaum, Modern Operating Systems (2nd Edition), 2001. First in step 200, the execution unit 106 itself is initialized. In step 210, execution unit 106 registers with manager module 104. By registering, execution unit 106 informs the manager module of its existence. It should be understood that in accordance with the present invention multiple execution units may register with manager module 104. In step 220 the execution unit processes a work unit as appropriate. Once there are no additional basic work units to be processed, the execution unit 106 de-registers with manager module 104 (step 230) and terminates (step 240).

Referring now to FIG. 6(b), the operation of an external agent which adjusts some parameter to cause the utility to throttle is shown. Typically, the external agent would be an operating system service. In accordance with the present invention, external agents or operating system services could be used by either or both controller 102 or manager 104. First in step 500, the external agent 110 registers with manager module 104. By registering, external agent 110 informs the manager module of its existence. It should be understood that in accordance with the present invention multiple external agents may register with manager module 104. In step 510 the external agent obtains a list of execution units requiring throttling from manager module 104. In step 520, the external agent obtains the throttling level to apply to execution unit 106. In practice, this step may be combined with step 510. In step 530, external agent 110 applies the appropriate throttling control to the appropriate execution unit. The process is repeated while there are additional execution units as indicated by decision block 540. Once the external agent 110 has completed its work, the external agent deregisters with manager module 104 (step 550).

Referring now to FIG. 7, the operation of an execution unit is generally shown where throttling is accomplished by self-throttling. Self-throttling in this situation may be accomplished in numerous ways, which by way of example include, but are not limited to, reduce the parallelism of a multi-process utility so the utility will run slower, reducing memory consumption by the utility, and changing the granularity of locking. First in step 280, the execution unit 106 itself is initialized. In step 290, execution unit 106 registers with manager module 104. By registering, execution unit 106 informs the manager module of its existence. It should be understood that in accordance with the present invention multiple execution units may register with manager module 104. In step 300 the execution unit processes a work unit as appropriate. In step 310 the throttling level is obtained, preferably from manager module 104 as discussed above. In step 320 throttling occurs, if necessary. The process is repeated while there are additional work units to process as indicated by decision block 330. Once the execution unit 106 has completed its work, the execution unit 106 deregisters with manager module 104 (step 340) and terminates (step 350).

Referring now to FIG. 8, the operation of an execution unit is generally shown where throttling is accomplished by self-throttling through a self-imposed sleep (SIS). SIS relies on an operating system service: a sleep system call which is parameterized by a time interval and is discussed in detail herein below. Most modern operating systems provide some version of a sleep system call that makes the process or thread not schedulable for the specified interval. First in step 400, the execution unit 106 itself is initialized. In step 410, execution unit 106 registers with manager module 104. By registering, execution unit 106 informs the manager module of its existence. It should be understood that in accordance with the present invention multiple execution units may register with manager module 104. In step 420 work is gotten and the throttling level is obtained, preferably from manager module 104 as discussed above. In step 430 work is performed. Work is performed until the execution unit has worked long enough to throttle as indicated by decision block 430. If it is appropriate to throttle, at step 450 the SIS throttling mechanism is invoked. The throttle point should preferably be inserted in each place where some basic work unit is processed. Care must be taken that highly contended resources (e.g., locks) are not held during the execution of this throttle. The process continues until the execution unit has completed its work, as indicated by decision block 460. the throttling level is obtained, preferably from manager module 104 as discussed above. Once the execution unit 106 has completed its work, the execution unit 106 deregisters with manager module 104 (step 470) and terminates (step 480).

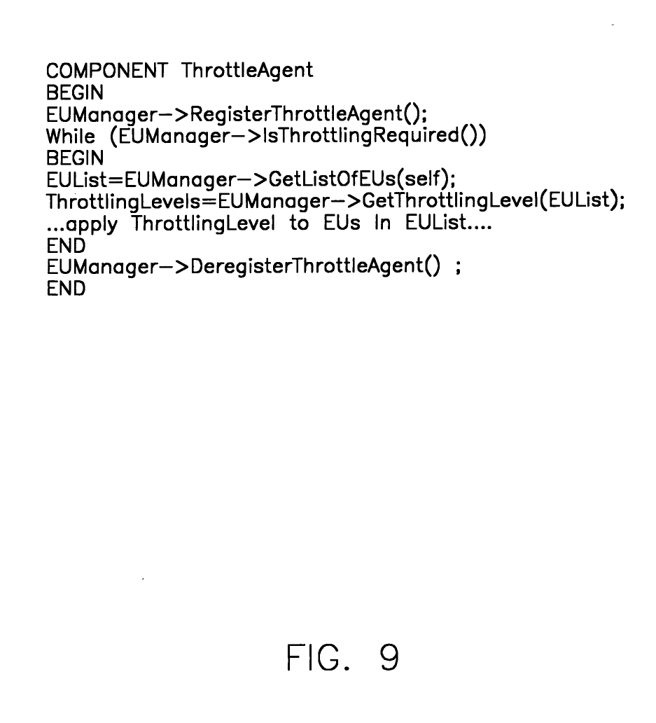

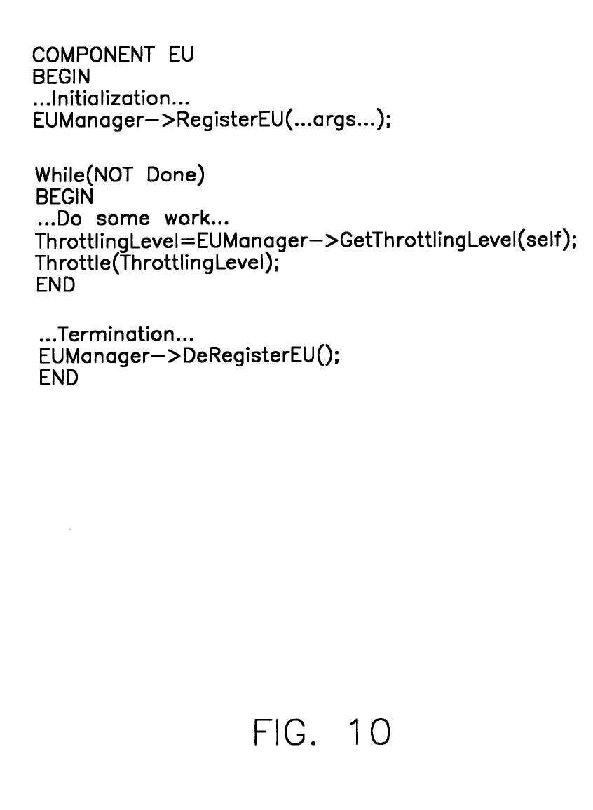

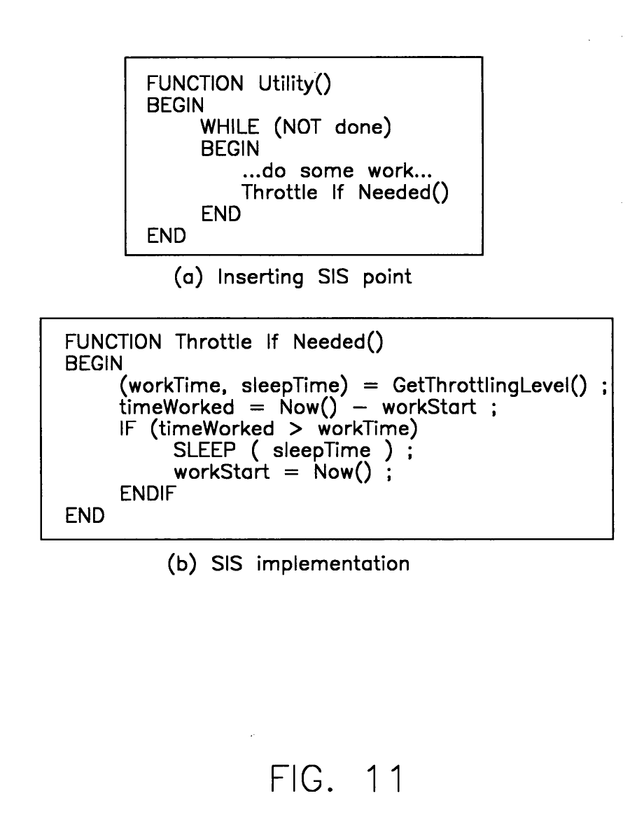

Referring now to FIGS. 9, 10, and 11, it is shown how the flow of execution unit 106 can be augmented by inserting various points in accordance with various embodiments of the present invention. These figures address the situations where insertion occurs in an external agent (FIG. 9), in an execution unit where throttling is accomplished generally by self-throttling (FIG. 10), and in an execution unit where throttling is accomplished by SIS self-throttling (FIG. 11).

Referring now to FIG. 11, a throttling API that uses a SIS in accordance with the present invention is shown. To elaborate, many administrative utilities are structured as an outer loop that iterates over some object. For example, in DB 2 BACKUP, the outer loop iterates over low-level storage units to be written to the backup device; in garbage collection, see Wilson, P. R.: Uniprocessor garbage collection techniques, Proceedings of the International Workshop on Memory Management, Springer-Verlag (1992) 1-42, iteration is done across memory addresses. FIG. 11(a) depicts how this flow can be augmented by inserting a throttle point called ThrottleIfNeeded ( ) into execution units in accordance with the present invention. As shown in FIG. 11(b), the control of execution units is regulated by two variables: a workTime and a sleepTime. These values are in turn obtained by calling GetThrottlingLevel ( ), is preferably obtained from manager module 104. The throttle point ensures that when it has been at least workTime seconds since the thread was last forced to sleep, the thread sleeps for the prescribed sleepTime. As mentioned above, in order to get the maximum benefit from this API, the throttle point should preferably be inserted in each place where some basic work unit is processed. Care must be taken that highly contended resources (e.g., locks) are not held during the execution of this API.

The sum of workTime and sleepTime constitutes the time between taking actions that affect utility execution. This is referred to as the action interval. In accordance with the present invention, the action interval is forced to be a constant that is large enough to encompass several iterations of the work loop of the utility. This value can be either fixed by the system developer or determined at runtime. With a fixed action interval, the throttling level can now be described by one parameter: the sleep fraction, defined as

$$\frac{sleepTime}{action interval}$$

which will be a value between 0 and 1. That is, if the sleep fraction is 0, the utility is unthrottled. If the sleep fraction is 1, the execution unit or utility is fully throttled.

FIG. 11(a) corresponds to FIGS. 9 and 10. While the control variables for FIGS. 9 and 10 are not shown, their selection depends, among other things, upon the desires of the system designer, as will be understood by those skilled in the art. These control variables operate in a manner similar to that shown in FIG. 11(b), as again will be understood by those skilled in the art.

The disclosure now turns to a discussion of empirical assessments for the presently preferred SIS throttle. These assessments were made using a modified version of the IBM DB2 Universal Database v8.1 running on a 4-CPU RS/6000 with 2 GB RAM, with the AIX 4.3.2 operating system. To emulate client activity, an artificial transaction processing workload was applied which is similar to the industry-standard TPC-C database benchmark. This workload is considered the “production” load. The database is striped over 8 physical disks connected via an serial storage architecture (SSA) disk subsystem. The execution unit (utility) focused on is an online BACKUP of this database. This backup is parallelized, consisting of multiple processes that read from multiple tablespaces, and multiple other processes that write to separate disks.

For most of the measurements shown here, the workload was run for an initial warm-up period of 10 minutes to populate the buffer pools and other system structures. After this, the utility was invoked under various conditions. The number of emulated users was kept constant for the duration of the run. Performance metrics such as throughput, average transaction times, and system utilizations for the entire run were measured.

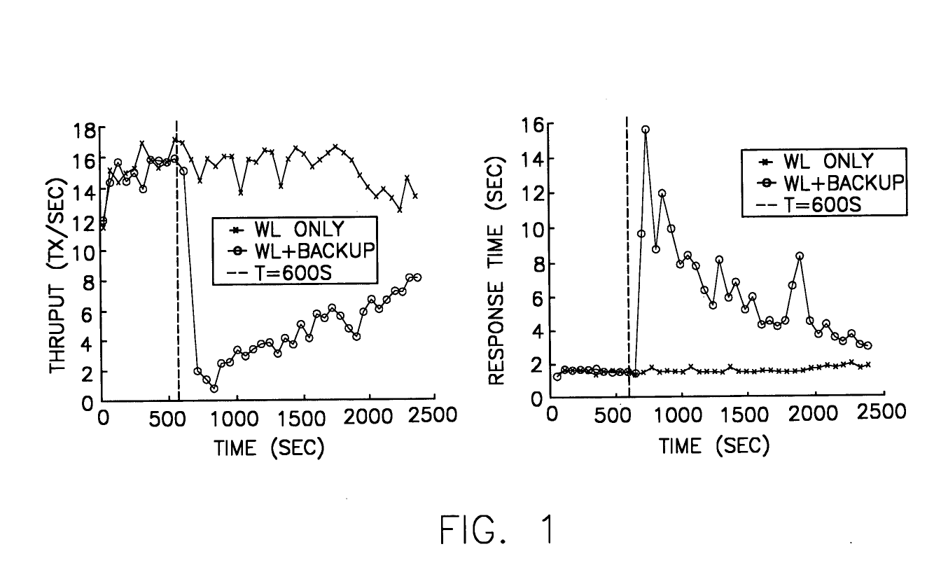

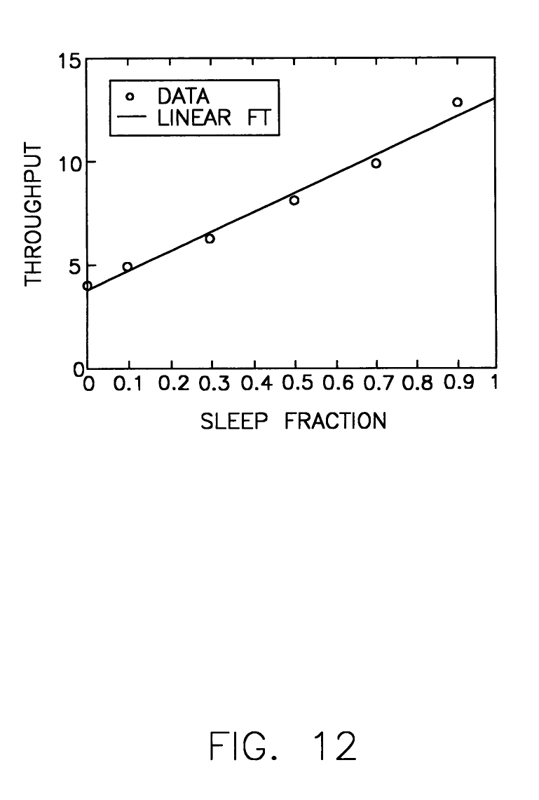

To determine the effectiveness of the SIS throttling, several database execution units (utilities) were altered in accordance with the present invention. Referring now to FIG. 12, the average throughput is shown for the workload of 25 emulated users while BACKUP is run at different throttling levels, varying the sleep fraction from 0.0 to 1.0 across runs. Each datapoint represents the average performance over a 20-minute run where the throttling level was kept constant at the indicated level. SIS has a nearly linear effect in reducing the degradation of the utility on the workload. It should be noted that at a sleep fraction of 1, the utility is maximally throttled, hence the workload performance is close to the no-utility case of FIG. 1.

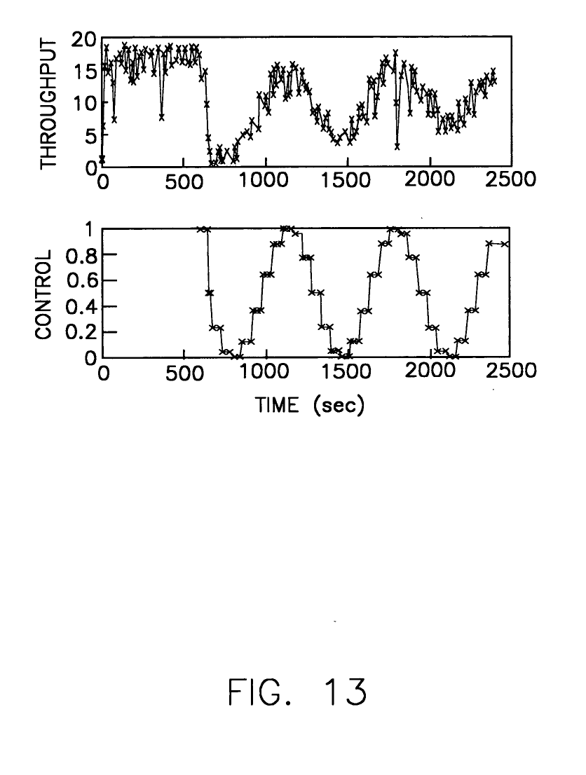

Referring now to FIG. 13, the dynamic effect of the control mechanism is shown. This permits an understanding of factors like delays in effecting a new control value, and transient behaviors like overshoot. The utility is started at 600 sec, after which the throttling level is varied in a sinusoid pattern, where each throttling level is maintained for 60 seconds. The sleep fraction is a nice effector for throttling since it has an effect on the utility impact with almost no delay.

It should be understood that from an implementation standpoint, the internal throttling mechanism (SIS or otherwise) requires the execution unit (administrative utility) to be modified. Thus, it is usable mainly by the developers of the utility or software system. In order to insert the SIS points, the main work phase of the utility should be identifiable. This may prove problematic in cases of some legacy systems where the source code is not available or not well understood. However, for current or new software, the SIS mechanism gives developers the ability to build a general and effective throttling capability into their systems. The runtime overhead of this scheme (in terms of its effect on the workload) is not detectable, especially since any amount of throttling is better than no throttling at all. Furthermore, an internal throttling mechanism, particularly an enforced sleep mechanism, is easily applied to a wide variety of tasks and provides an adequate means for regulating the consumption of a wide range of resources including I/O, CPU and network bandwidth.

It is to be understood that the present invention, in accordance with at least one presently preferred embodiment, includes an arrangement for determining the utilities within the system, an arrangement for deriving a throttling level for each utility which quantifies the reduction in the rate at which the utility consumes resources, and an arrangement for enforcing the derived throttling level for each utility, all of which may be implemented on at least one general-purpose computer running suitable software programs. These may also be implemented on at least one Integrated Circuit or part of at least one Integrated Circuit. Thus, it is to be understood that the invention may be implemented in hardware, software, or a combination of both.

If not otherwise stated herein, it is to be assumed that all patents, patent applications, patent publications and other publications (including web-based publications) mentioned and cited herein are hereby fully incorporated by reference herein as if set forth in their entirety herein.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

1. A system for regulating resource consumption in a computer system used for utility work and production work, the apparatus comprising:
an arrangement for determining the utilities within the system;
an arrangement for deriving a throttling level for each utility which quantifies the reduction in the rate at which the utility consumes resources; and
an arrangement for enforcing the derived throttling level for each utility.

2. The system according to claim 1, wherein said arrangement for determining ascertains whether the utility has indicated its presence with the system.

3. The system according to claim 2, wherein indicating the presence of the utility within the system comprises the utility registering with a utility manager.

4. The system according to claim 2, wherein said arrangement for enforcing the throttling level is implemented within the utility.

5. The system according to claim 4, wherein the throttling level is enforced through a self-imposed sleep.

6. The system according to claim 4, wherein the utility is a multi-process utility and the throttling level is enforced by reducing the parallelism of the multi-processes.

7. The system according to claim 4, wherein the throttling level is enforced by reducing the amount of memory used by the utility.

8. The system according to claim 4, wherein the throttling level is enforced by changing the granularity of locking.

9. The system according to claim 4, wherein the throttling level is enforced by reducing the amount of processing accomplished by the utility.

10. The system according to claim 2, wherein said arrangement for enforcing the throttling level is implemented by an agent external to the utility.

11. The system according to claim 9, wherein the throttling level is enforced by reducing the operating system priority of the utility.

12. A method for regulating resource consumption in a computer system used for utility work and production work, the method comprising the steps of:
determining the utilities within the system;
deriving a throttling level for each utility which quantifies the reduction in the rate at which the utility is processed or otherwise consumes resources; and
enforcing the derived throttling level for each utility.

13. The method according to claim 12, wherein said determining step comprises ascertaining whether the utility has indicated its presence with the system.

14. The method according to claim 13, wherein indicating the presence of the utility within the system comprises the utility registering with a utility manager.

15. The method according to claim 13, wherein said enforcing step comprises the throttling level being implemented within the utility.

16. The method according to claim 15, wherein the throttling level is enforced through a self-imposed sleep.

17. The method according to claim 15, wherein the utility is a multi-process utility and the throttling level is enforced by reducing the parallelism of the multi-processes.

18. The method according to claim 15, wherein the throttling level is enforced by reducing the amount of memory used by the utility.

19. The method according to claim 15, wherein the throttling level is enforced by changing the granularity of locking.

20. The method according to claim 15, wherein the throttling level is enforced by reducing the amount of processing accomplished by the utility.

21. The method according to claim 13, wherein said enforcing step is accomplished by having an agent external to the utility implement the throttling level.

22. The method according to claim 21, wherein the throttling level is enforced by lowering the operating system priority of the utility.

23. A program storage device readable by machine, tangibly embodying a program of instructions executable by the machine to perform method steps for regulating resource consumption in a computer system used for utility work and production work, the method comprising, said method comprising the steps of:
determining the utilities within the system;
deriving a throttling level for each utility which quantifies the reduction in the rate at which the utility consumes resources; and
enforcing the derived throttling level for each utility.
